(19) United States
(12) Patent Application Publication
(10) Pub. No.: US 2004/0163500 A1
(43) Pub. Date: Aug. 26, 2004

(54) Socket with fastener holder

(76) Inventor: Leonard Michael Walsh, Bristol, CT (US)

Correspondence Address: PRATT & WHITNEY, 400 MAIN STREET, MAIL STOP: 132-13, EAST HARTFORD, CT, 06108, US

(21) Appl. No.: 10/761,731

(22) Filed: Jan. 21, 2004

Related U.S. Application Data
(60) Provisional application No. 60/319,890, filed on Jan. 21, 2003.

(51) Int. Cl. B25B 13/02

(52) U.S. Cl. 81/125

(57) ABSTRACT

A tool comprising a holder and a retainer. The holder has: a receiving area for accepting a fastener in an insertion direction; and a notch in a sidewall transverse to the insertion direction and in communication with the receiving area. The retainer resides in the notch and extends into the receiving area. The retainer deflects away from the receiving area during insertion of the fastener and provides a bias force to the fastener to retain the fastener within the holder. The retainer has: an arcuate medial section; and a pair of arms extending from the medial section. Each arm has a bent tip. The medial section and the tips conform to the shape of the holder. Preferably, the tool is a socket wrench assembly.

### CROSS-REFERENCE TO RELATED APPLICATIONS

This Application claims the benefit of U.S. Provisional Patent Application No. 60/319,890 filed 21 Jan. 2003, herein incorporated by reference.

### BACKGROUND OF THE INVENTION

This invention relates to a socket. Specifically, this invention relates to a holder that retains a fastener within a socket.

Foreign Object Damage (FOD) is a key concern of the aerospace industry. FOD costs the industry an estimated 4 billion dollars per year. Examples of such foreign objects include loose hardware, tools, parts, pavement fragments, catering supplies, building materials, rocks, sand, luggage, pens, coins, badges, hats, trash and even wildlife.

Most FOD occurs when the gas turbine engine ingests a foreign object during aircraft operations. These operations could occur on the airport grounds (e.g. ramps, taxiways, runways) or during flight. To prevent such occurrences, airports try to keep the airports operations area free of debris and wildlife.

Some FOD can occur, however, from objects resident in or around the engine before an aircraft operation begins. These foreign objects are typically left behind during assembly or disassembly of an aircraft component. For example, a technician could drop a fastener from a socket during a maintenance operation.

Various devices exist that may help prevent a technician from dropping the fastener from the socket. A discussion of several of these devices follows. U.S. Pat. No. 3,145,595 describes a socket wrench with a magnetic nut holder. While perhaps satisfactory for ferrous materials, the holder does not function with non-ferrous materials.

U.S. Pat. No. 5,896,792 describes a thin, flexible plastic holder that enters the interior of the socket along with the fastener. The holder creates an interference fit between the fastener and the socket, thus retaining the fastener in the socket. This solution appears to introduce a problem (FOD created by the use of a thin, flexible plastic piece) in attempt to resolve the original situation (FOD created by the fastener).

U.S. Pat. No. 3,630,107 describes a retainer made from wire that generally surrounds the outside of the socket. A portion of the wire extends over the rim of the socket and into the interior to frictionally retain the fastener therein. The portion of the wire that extends over the rim may interfere with the ability to tighten the fastener fully during use.

U.S. Pat. No. 4,744,273 describes a retainer that extends along the outside of the socket. Similar to U.S. Pat. No. 3,630,107, the retainer extends past the socket and may interfere with the ability of the socket to secure the fastener properly. In addition, the fingers of the retainer extend over the head of the fastener when fully inserted. This may require the technician to spread the fingers to release the fastener from the socket.

Finally, U.S. Pat. No. 4,060,113 describes a spanner having an internal leaf spring to frictionally retain the fastener. Entirely internal, the technician has no external cues whether the leaf spring has exited within the spanner ( i.e. producing FOD).

### SUMMARY OF INVENTION

It is an object of the present invention to provide an improved socket wrench assembly.

It is an object of the present invention to provide an ergonomic socket wrench assembly.

It is a further object of the present invention to provide a socket that retains a fastener therein while manipulating the socket wrench assembly.

It is a further object of the present invention to provide a retainer that does not interfere with proper use of the socket wrench assembly.

These and other objects of the present invention are achieved in one aspect by a tool, comprising a holder and a retainer. The holder has: a receiving area for accepting a fastener in an insertion direction; and a notch transverse to said insertion direction and in communication with the receiving area. The retainer resides in the notch and extends into the receiving area. The retainer deflects away from the receiving area during insertion of the fastener and provides a bias force to the fastener to retain the fastener within the holder.

These and other objects of the present invention are achieved in another aspect by a socket assembly, comprising a socket and a retainer. The socket has: a receiving area for accepting a fastener in an insertion direction; and a notch transverse to the insertion direction and in communication with the receiving area. The retainer resides in the notch and extends into the receiving area. The retainer deflects away from the receiving area during insertion of the fastener and provides a bias force to the fastener to retain the fastener within the holder.

These and other objects of the present invention are achieved in another aspect by a retainer secured to a holder for preventing a fastener from departing said holder. The retainer comprises: an arcuate medial section; and a pair of arms extending from the medial section. Each arm has a bent tip. The medial section and the tips conform to the shape of the holder.

### BRIEF DESCRIPTION OF DRAWINGS

Other uses and advantages of the present invention will become apparent to those skilled in the art upon reference to the specification and the drawings, in which:

FIG. 1 is a perspective view, in partial cross-section, of a conventional socket wrench assembly;

FIG. 2 is an end view of the socket from FIG. 1;

FIG. 3 is an exploded, perspective view of one embodiment of a socket of the present invention;

FIGS. 4a and 4b are perspective views of the socket of FIG. 2 before and after, respectively, accepting a fastener; and

FIGS. 5a and 5b are plan views of the socket of FIG. 2 before and after, respectively, accepting a fastener.

### DETAILED DESCRIPTION

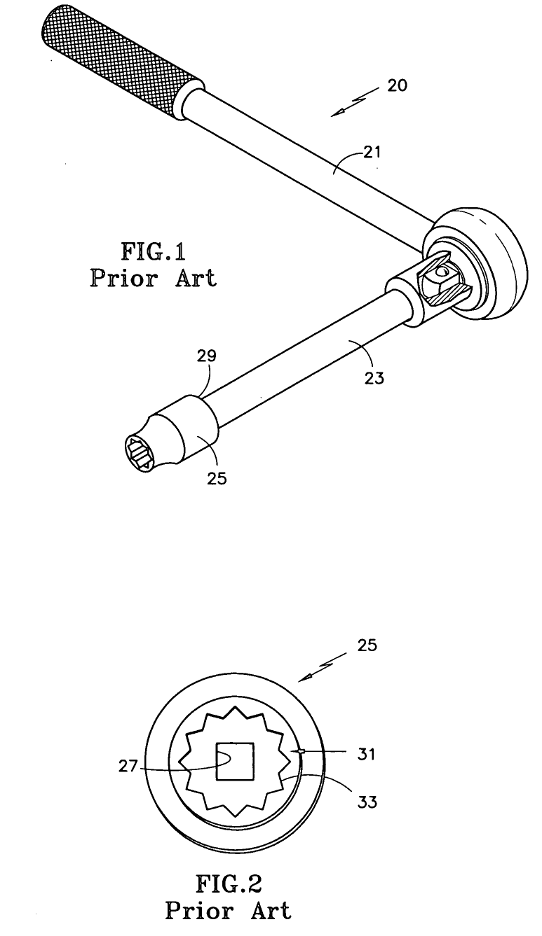

FIGS. 1 and 2 display a conventional socket wrench assembly 20. The assembly 20 includes a socket wrench 21, extension 23 and socket 25. The socket 25 has an annular shape. Except for an aperture 27 to receive the extension 23, a first end 29 of the socket is closed. The opposite end of the socket is open and leads to a fastener receiving area 31. The area 31 has a plurality of facets 33 that correspond to the shape of a fastener (such as shown in FIG. 4b).

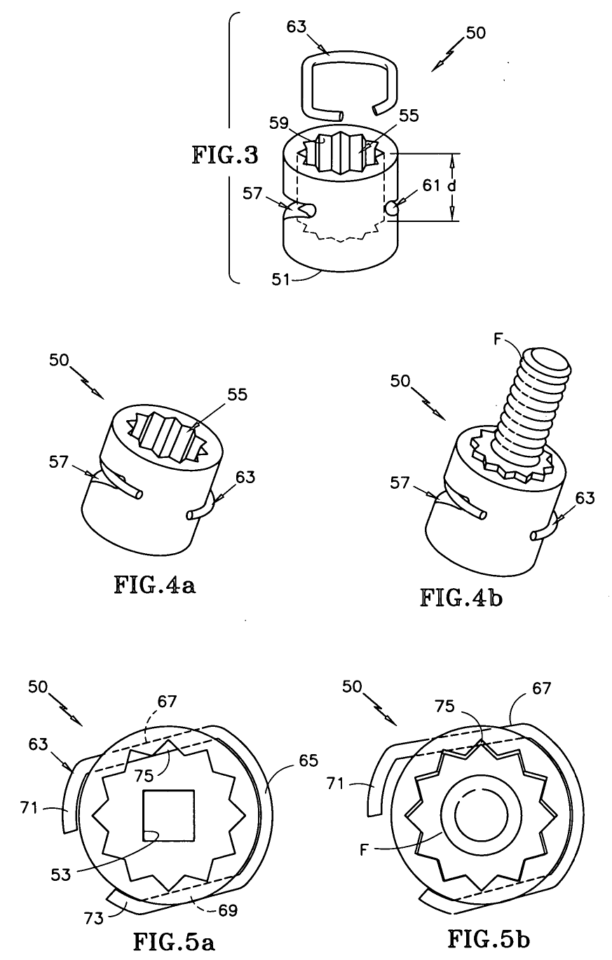

FIGS. 3-5b display one embodiment of a socket assembly 50 of the present invention. The socket 50 could be made from any suitable material, such as metal. The socket 50 could also have any suitable plating or coating, such as a black oxide coating. Although described herein with respect to socket 50, the present invention could be used on any tool that accepts a fastener F.

Similar to socket 25, socket 50 has an annular shape with a closed first end 51 (except for aperture 53 to receive the extension of the socket wrench). The opposite end of the socket is open and leads to a fastener receiving area 55. The fastener receiving area 55 has a plurality of facets 59 that correspond to the shape of fastener F such as the 12-point bolt shown in FIG. 4b. The area 55 holds the fastener F and could have any shape to correspond to a desired fastener.

Socket 50 includes an elongated notch 57. The notch 57 extends through the sidewall to communicate with the fastener receiving area 55. The notch 57 could extend transverse to the insertion direction of the fastener F. Any suitable technique, such as kerf sawing, cutting with an abrasive wheel, or Electrical Discharge Machining (EDM) could be used to form the notch 57 in an existing socket 50. For sockets formed by casting, the cast producing the socket 50 could include the notch 57. As seen in FIG. 3, socket 50 could have another notch 61. In fact, socket 50 could have any number of notches, not just the two notches 57, 61 shown in the figures. Similar to notch 57, notch 61 extends into the sidewall of the socket 50. For small sockets 50, the notch 57 preferably does not reach the fastener receiving area 55. For larger sockets 50, the notch 57 preferably enters the fastener receiving area 55 (not shown). The purpose of the notches 57 will be described in detail below. The fastener receiving area 55 has a depth d (in the fastener insertion direction). Preferably, the notches 57, 61 reside approximately halfway along the depth. In other words, the notches 57, 61 reside approximately 0.5 d from the open end of the socket. The notches 57, 61 could, however, reside at other locations on the socket 50.

The notches 57, 61 receive a retainer. FIG. 3 shows one embodiment of the retainer, a split ring 63. The split ring 63 is preferably made from bent wire. A variety of socket sizes ( e.g. ¼″-1 ¼″) of the present invention could use 0.040″ diameter wire, although larger diameters could also be used. Although shown as a circular cross-section, the split ring 63 could have other cross-sectional shapes, such as triangular, rectangular or square (with or without chamfered edges). In fact, the use of such alternate shapes allows the present invention to use larger diameter wire for the retainer 63. The larger wire diameter allows the present invention to operate on larger sockets that can accept larger fasteners.

The split ring 63 includes an arcuate medial section 65 flanked by arms 67, 69. The split ring 63 is generally planar. The distal ends of the arms 67, 69 include tips 71, 73 bent into an arcuate configuration. Although shown in the figures as being generally linear, the arms 67, 69 could have other shapes.

When installed on the socket 50, the split ring 63 extends along the outer perimeter of the sidewall. The split ring 63 is positioned relative to the notches 67, 69 so that the arms 67, 69 extend through the notches 57, 61. As seen in FIGS. 5a and 5b, the medial section of the arms 67, 69 reside in the notches 57, 61. The section of the arm 67 that extends through the notch 57 also extends into the fastener receiving area 55. In other words, the arm 67 has an exposed portion 75 within the fastener receiving area 55. The medial section 65 of the split ring 63 preferably conforms to the outer diameter of the socket 50.

During insertion, the fastener F contacts the exposed portion 75 of the split ring 63. As seen in FIGS. 5a and 5b, the exposed portion 75 of the arm can engage two points of the fastener F. Alternatively, the exposed portion 75 could extend through the fastener receiving area 55 so engage only one point or more than two points of the fastener F. The round cross-section of the wire provides a suitable tapered surface to prevent binding between the split ring 63 and the fastener F. When fully inserted, the fastener F urges the exposed portion 75 of the split ring in a radially outward direction. As seen in FIG. 5b, the fastener F has displaced the arm 67 and the tip 71 away from the socket 50.

The split ring 63 acts as a spring to retain the fastener F within the socket 50. In other words, the spring characteristics of the split ring 63 displaced by the fastener F provide a suitable bias force to the fastener F to retain the fastener F within the socket 50. Specifically, the split ring 63 biases the fastener F against the facets 59 opposite notch 57. This allows the technician to manipulate the socket wrench assembly in any manner without dropping the fastener F. Importantly, the technician no longer has to use two hands when manipulating the socket wrench assembly (one holding the wrench, the other holding the fastener F within the socket 50).

The round cross-section of the wire helps prevent binding between the split ring 63 and the fastener F when separating the socket 50 from the fastener F. The technician need only overcome the friction force created by the spring bias of the split ring 63 to separate the socket 50 from the fastener F.

Extending around a substantial portion of the circumference of the socket 50, retention of the split ring 63 to the socket 50 is generally ensured. If necessary, however, the split ring 63 could secure to the socket 50 in any known fashion. For example, the medial section 65 of the split ring 63 could be welded to the socket 50 using MIG or TIG welding.

In fact, by securing the retainer to the socket 50, the retainer no longer must extend substantially around the circumference of the socket 50. The retainer could merely be a segment that extends through the notch 57. One end, or both ends, of the retainer could be secured to the socket 50. With only one end of the retainer secured to the socket 50, the cantilever arrangement would provide the spring bias to the fastener F. With both ends of the retainer secured to the socket 50, the spring characteristics of the wire would bias the fastener F.

The present invention has been described in connection with the preferred embodiments of the various figures. It is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

1. A tool, comprising:
a holder, having:
a receiving area for accepting a fastener in an insertion direction; and
a first notch transverse to said insertion direction, said notch in a sidewall of said holder and in communication with said receiving area; and
a retainer extending through said first notch and into said receiving area;
wherein said retainer deflects away from said receiving area during insertion of said fastener and provides a bias force to said fastener to retain the fastener within said holder.

2. The tool of claim 1, wherein said holder has a second notch through which said retainer extends.

3. The tool of claim 2, wherein said second notch is opposite said first notch.

4. The tool of claim 1, wherein said retainer comprises a split ring.

5. The tool of claim 1, wherein said retainer is a spring.

6. The tool of claim 1, wherein said receiving area has a depth and said first notch resides approximately at a midpoint of said depth.

7. The tool of claim 1, wherein said holder has an end that accepts said fastener and said retainer does not reside at said end.

8. A socket assembly, comprising
a socket, having:
a receiving area for accepting a fastener in an insertion direction; and
a first notch in a sidewall transverse to said insertion direction, said first notch in communication with said receiving area; and
a retainer extending in said notch and through into said receiving area;
wherein said retainer deflects away from said receiving area during insertion of said fastener and provides a bias force to said fastener to retain said fastener within said holder.

9. The socket assembly of claim 8, wherein said holder has a second notch through which said retainer extends.

10. The socket assembly of claim 9, wherein said second notch is opposite said first notch.

11. The socket assembly of claim 8, wherein said retainer comprises a split ring.

12. The socket assembly of claim 8, wherein said retainer is a spring.

13. The socket assembly of claim 8, wherein said receiving area has a depth and said notch resides approximately at a midpoint of said depth.

14. The socket assembly of claim 8, wherein said holder has an end that accepts said fastener and said retainer does not reside at said end.

15. A retainer secured to a holder for preventing a fastener from departing said holder, comprising:
an arcuate medial section; and
a pair of arms extending from said medial section, each of said arms having a bent tip;
wherein said medial section and said tips conform to the shape of said holder.

16. The retainer of claim 15, wherein said retainer is generally planar.

17. The retainer of claim 15, wherein said arms are generally linear.

18. The retainer of claim 15, wherein said retainer is a split ring.

19. The retainer of claim 15, wherein said retainer is a spring.

20. The retainer of claim 15, wherein said retainer comprises wire.
